(19) United States
(12) Patent Application Publication
(10) Pub. No.: US 2019/0199713 A1
(43) Pub. Date: Jun. 27, 2019

(54) AUTHENTICATION VIA MIDDLE EAR BIOMETRIC MEASUREMENTS

(71) Applicant: PAYPAL, INC., San Jose, CA (US)

(72) Inventor: Zachary Joseph Berman, San Jose, CA (US)

(73) Assignee: PAYPAL, INC.

(21) Appl. No.: 15/850,886

(22) Filed: Dec. 21, 2017

(51) Int. Cl. H04L 29/06; G06K 9/00; G06K 9/20; H04R 1/10

(52) U.S. Cl. CPC H04L 63/0861; H04R 1/1091; G06K 9/209; G06K 9/00885

(57) ABSTRACT

Methods and systems for authenticating a user via middle ear biometric measurements are described. An authentication request is received and in response to the received authentication request, an imaging device is caused to scan the middle ear characteristics of the user. A determination is made whether the scanned middle ear characteristics of the user is a match to predefined middle ear characteristics associated with the user. The request is authenticated in response to a determination of a match.

### TECHNICAL FIELD

The subject technology generally relates to user authentication on an electronic device and more particularly, relates to a system and method that use middle ear biometric measurements as one of one or more authentication factors.

### BACKGROUND

The use of electronic devices that store personal information and perform transactions has become increasingly more common over the years. For example, in an age where digital payments have become more prevalent, smartphones are tasked with storing a wealth of sensitive information which is used to conduct financial and other sensitive transactions. Consequently, securing these electronic devices from unscrupulous hackers is of upmost importance.

Traditionally, passwords or passcodes have been used to lock electronic devices. In an effort to reduce the amount of friction in the unlocking process, additional forms of unlocking have been introduced, such as fingerprint and face recognition. While these authentication processes may protect the average user from most hacks, these processes are not indomitable, especially as hackers become more sophisticated. Accordingly, alternative authentication factors continue to be introduced to be used in replacement of or in conjunction with the traditional factors.

The introduction of new authentication factors provides another hurdle against hackers trying to compromise the electronic device. However, there is a need for these additional factors to be simple for an authorized user to authenticate, but hard for a hacker to compromise. If the authentication becomes too involved for the authorized user, it may be shut off and thus defeating the purpose of the intended use of the authentication.

One form of authentication that generally creates minimal overhead for an authorized user/owner of an electronic device is authentication that involves biometrics unique to the authorized user/owner. Certain types of biometrics also lend itself to continuous authentication of the authorized user, thereby adding a layer of security without requiring additional effort from the user.

### SUMMARY

According to various aspects of the subject technology, a system for authenticating a user via middle ear biometric measurements is provided. The system includes an imaging device operative to scan middle ear characteristics of a user. The system further includes a non-transitory memory that stores instructions, and one or more hardware processors coupled to the non-transitory memory that is configured to read the instructions from the non-transitory memory to cause the system to perform certain operations. An authentication request is received and in response to the received authentication request, an imaging device is caused to scan the middle ear characteristics of the user. A determination is made whether the scanned middle ear characteristics of the user is a match to predefined middle ear characteristics associated with the user. The request is authenticated in response to a determination of a match.

According to various aspects of the subject technology, a method for authenticating a user via middle ear biometric measurements is also provided. A request for continuous authentication is received in response to an initiation of an application on a computing device. An imaging device is caused to continuously scan middle ear characteristics of a user upon initiation of the application. The application is allowed to operate when a determination that the scanned middle ear characteristics of the user is a match to predefined middle ear characteristics associated with the user is made. The application is discontinued from operating when a determination that the scanned middle ear characteristics of the user is not a match to the predefined middle ear characteristics associated with the user is made.

According to various aspects of the subject technology, a non-transitory machine-readable medium having stored thereon machine-readable instructions executable to receiving an authentication request. In response to the received authentication request, an imaging device integrated into a headphone is caused to scan the middle ear characteristics of a user. A determination that the scanned middle ear characteristics of the user is a match to predefined middle ear characteristics associated with the user is made. In response to determining the match, instructions for entering a string of text on a computing device is played through the headphone. A determination that the entered string of text matches a predefined string of text is made and the user is authenticated for the computing device in response to determining the match in the string of text.

Additional features and advantages of the subject technology will be set forth in the description below, and in part will be apparent from the description, or may be learned by practice of the subject technology. The advantages of the subject technology will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide further understanding of the subject technology and are incorporated in and constitute a part of this specification, illustrate aspects of the subject technology and together with the description serve to explain the principles of the subject technology.

FIG. 1 is a block diagram of an exemplary computing system on which authentication of middle ear biometric measurements may be performed.

FIG. 2 is a block diagram of an exemplary computer system suitable for implementing one or more devices of the computing system in FIG. 1.

FIG. 3 provides an illustration of the anatomy of the ear.

FIG. 4 is a flow diagram illustrating an exemplary authentication process using middle ear biometric measurements.

FIG. 5 is an example of components of the system for performing authentication based on middle ear biometric measurements.

### DETAILED DESCRIPTION

Personal electronic devices (e.g., smartphones, desktops, tablets, laptops, etc.) are used for a variety of purposes including but not limited to real-time communications, financial transactions, and the transmission of or sharing of data. For these activities to be properly conducted, a user must be authenticated to ensure that the user is who the user claims to be. For example, during a conference call where multiple users may dial in to share sensitive information, it may important to authenticate that each participant is who he holds himself out to be. Typically, a dial-in number and access code is distributed to authorized participants; however, such security measures rely on the fact that no unauthorized user gets a hold of the dial-in number and access code. If an unauthorized user does obtain the dial-in number and access code, this user could easily gain access to sensitive information that was meant to be maintained in private. In a similar manner, an unauthorized user may gain access to a password for a particular authorized user and gain unrestricted access to the authorized user's account. Ultimately, the security of the conference call and the account in these two examples are only as strong as the ability of the authorized user(s) to keep the access code and passwords a secret.

By measuring middle ear biometrics, the system leverages a unique characteristic of the human body to authenticate an individual. Since the middle ear characteristics are unique to an individual, and since the middle ear is not visible without close inspection, the middle ear provides a biometric that's difficult to replicate and thus extremely useful for uniquely identifying and authenticating a user.

This specification includes references to “one embodiment,” “some embodiments,” or “an embodiment.” The appearances of these phrases do not necessarily refer to the same embodiment. Particular features, structures, or characteristics may be combined in any suitable manner consistent with this disclosure.

“First,” “Second,” etc. As used herein, these terms are used as labels for nouns that they precede, and do not necessarily imply any type of ordering (e.g., spatial, temporal, logical, cardinal, etc.). Furthermore, various components may be described or claimed as “configured to” perform a task or tasks. In such contexts, “configured to” is used to connote structure by indicating that the components include structure (e.g., stored logic) that performs the task or tasks during operation. As such, the component can be said to be configured to perform the task even when the component is not currently operational (e.g., is not on). Reciting that a component is “configured to” perform one or more tasks is expressly intended not to invoke 35 U.S.C. § 112(f) for that component.

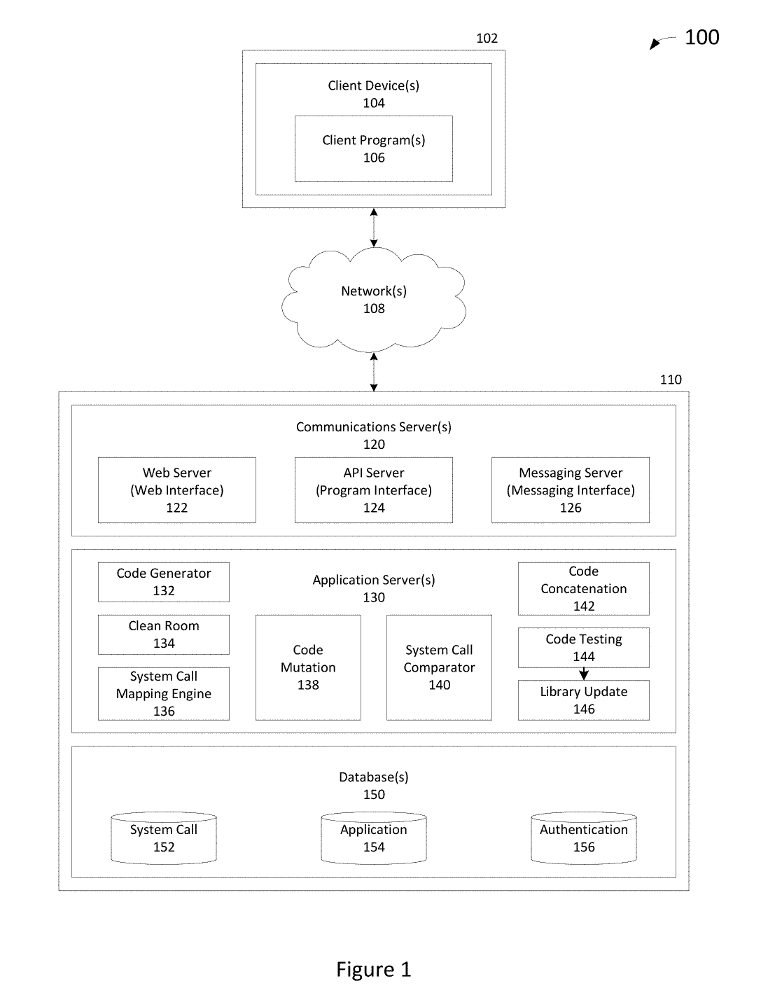

FIG. 1 illustrates an exemplary embodiment of a computing system adapted for implementing one or more embodiments disclosed herein to authenticate a user using middle ear biometric measurements. As shown, a computing system 100 may comprise or implement a plurality of servers, devices, and/or software components that operate to perform various methodologies in accordance with the described embodiments. Exemplary servers, devices, and/or software components may include, for example, stand-alone and enterprise-class servers running an operating system (OS) such as a MICROSOFT® OS, a UNIX® OS, a LINUX® OS, or other suitable OS. It may be appreciated that the servers illustrated in FIG. 1 may be deployed in other ways and that the operations performed and/or the services provided by such servers may be combined, distributed, and/or separated for a given implementation and may be performed by a greater number or fewer number of servers. One or more servers may be operated and/or maintained by the same or different entities.

Computing system 100 may include, among various devices, servers, databases and other elements, one or more clients 102 comprising or employing one or more client devices 104, such as a laptop, a mobile computing device, a tablet, a personal computer, a wearable device, and/or any other computing device having computing and/or communications capabilities in accordance with the described embodiments. Client devices 104 may include a cellular telephone, smart phone, electronic wearable device (e.g., smart watch, virtual reality headset), or other similar mobile devices that a user may carry on or about his or her person and access readily.

Client devices 104 generally may provide one or more client programs 106, such as system programs and application programs to perform various computing and/or communications operations. Exemplary system programs may include, without limitation, an operating system (e.g., MICROSOFT® OS, UNIX® OS, LINUX® OS, Symbian OS™, iOS, Android, Embedix OS, Binary Run-time Environment for Wireless (BREW) OS, JavaOS, a Wireless Application Protocol (WAP) OS, and others), device drivers, programming tools, utility programs, software libraries, application programming interfaces (APIs), and so forth. Exemplary application programs may include, without limitation, a payment system application, a web browser application, messaging application, contacts application, calendar application, electronic document application, database application, media application (e.g., music, video, television), location-based services (LBS) application (e.g., GPS, mapping, directions, positioning systems, geolocation, point-of-interest, locator) that may utilize hardware components such as an antenna, and so forth. One or more of client programs 106 may display various graphical user interfaces (GUIs) to present information to and/or receive information from one or more users of client devices 104. In some embodiments, client programs 106 may include one or more applications configured to conduct some or all of the functionalities and/or processes discussed below.

As shown, client devices 104 may be communicatively coupled via one or more networks 108 to a network-based system 110. Network-based system 110 may be structured, arranged, and/or configured to allow client 102 to establish one or more communications sessions between network-based system 110 and various client devices 104 and/or client programs 106. Accordingly, a communications session between client devices 104 and network-based system 110 may involve the unidirectional and/or bidirectional exchange of information and may occur over one or more types of networks 108 depending on the mode of communication. While the embodiment of FIG. 1 illustrates a computing system 100 deployed in a client-server operating environment, it is to be understood that other suitable operating environments and/or architectures may be used in accordance with the described embodiments.

Data communications between client devices 104 and the network-based system 110 may be sent and received over one or more networks 108 such as the Internet, a WAN, a WWAN, a WLAN, a mobile telephone network, a landline telephone network, personal area network, as well as other suitable networks. For example, client devices 104 may communicate with network-based system 110 over the Internet or other suitable WAN by sending and or receiving information via interaction with a website, e-mail, IM session, and/or video messaging session. Any of a wide variety of suitable communication types between client devices 104 and system 110 may take place, as will be readily appreciated. In particular, wireless communications of any suitable form (e.g., Bluetooth, near-field communication, etc.) may take place between client device 104 and system 110, such as that which often occurs in the case of mobile phones or other personal and/or mobile devices.

Network-based system 110 may comprise one or more communications servers 120 to provide suitable interfaces that enable communication using various modes of communication and/or via one or more networks 108. Communications servers 120 may include a web server 122, an API server 124, and/or a messaging server 126 to provide interfaces to one or more application servers 130. Application servers 130 of network-based system 110 may be structured, arranged, and/or configured to provide various online services to client devices that communicate with network-based system 110. In various embodiments, client devices 104 may communicate with application servers 130 of network-based system 110 via one or more of a web interface provided by web server 122, a programmatic interface provided by API server 124, and/or a messaging interface provided by messaging server 126. It may be appreciated that web server 122, API server 124, and messaging server 126 may be structured, arranged, and/or configured to communicate with various types of client devices 104, and/or client programs 106 and may interoperate with each other in some implementations.

Web server 122 may be arranged to communicate with web clients and/or applications such as a web browser, web browser toolbar, desktop widget, mobile widget, web-based application, web-based interpreter, virtual machine, mobile applications, and so forth. API server 124 may be arranged to communicate with various client programs 106 comprising an implementation of API for network-based system 110. Messaging server 126 may be arranged to communicate with various messaging clients and/or applications such as e-mail, IM, SMS, MMS, telephone, VoIP, video messaging, IRC, and so forth, and messaging server 126 may provide a messaging interface to enable access by client 102 to the various services and functions provided by application servers 130.

Application servers 130 of network-based system 110 may be servers that provide various services to client devices, such as tools for authenticating users and associated libraries. Application servers 130 may include multiple servers and/or components. For example, application servers 130 may include a code generator 132, clean room 134, system call mapping engine 136, code mutation engine 138, system call comparison engine 140, code concatenation engine 142, testing engine 144, and/or library update engine 146. These servers and/or components, which may be in addition to other servers, may be structured and arranged to identify those webpages that malicious content.

Application servers 130, in turn, may be coupled to and capable of accessing one or more databases 150 including system call database 152, application database 154, and/or authentication database 156. Databases 150 generally may store and maintain various types of information for use by application servers 130 and may comprise or be implemented by various types of computer storage devices (e.g., servers, memory) and/or database structures (e.g., relational, object-oriented, hierarchical, dimensional, network) in accordance with the described embodiments.

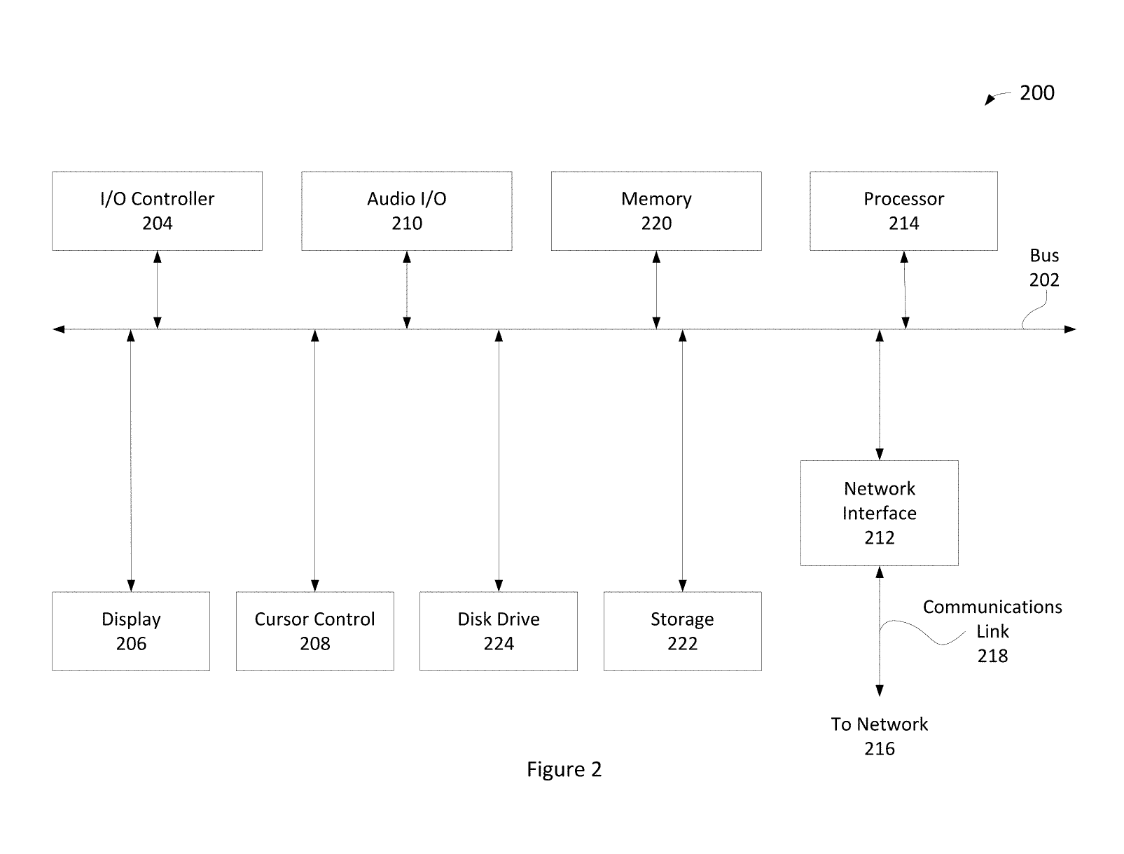

FIG. 2 illustrates an exemplary computer system 200 in block diagram format suitable for implementing on one or more devices of the computing system in FIG. 1. In various implementations, a device that includes computer system 200 may comprise a personal computing device (e.g., a smart or mobile phone, a computing tablet, a personal computer, laptop, wearable device, PDA, etc.) that is capable of communicating with a network. A service provider and/or a content provider may utilize a network computing device (e.g., a network server) capable of communicating with the network. It should be appreciated that each of the devices utilized by users, service providers, and content providers may be implemented as computer system 200 in a manner as follows. Additionally, as more and more devices become communication capable, such as smart devices using wireless communication to report, track, message, relay information and so forth, these devices may be part of computer system 200.

Computer system 200 may include a bus 202 or other communication mechanisms for communicating information data, signals, and information between various components of computer system 200. Components include an input/output (I/O) controller 204 that processes a user action, such as selecting keys from a keypad/keyboard, selecting one or more buttons, links, actuatable elements, etc., and sends a corresponding signal to bus 202. I/O controller 204 may also include an output component, such as a display 206 and a cursor control 208 (such as a keyboard, keypad, mouse, touchscreen, etc.). In some examples, I/O controller 204 may include an image sensor for capturing images and/or video, such as a complementary metal-oxide semiconductor (CMOS) image sensor, and/or the like. An audio I/O component 210 may also be included to allow a user to use voice for inputting information by converting audio signals. Audio I/O component 210 may allow the user to hear audio. Furthermore, the audio I/O component 210 may have an imaging device (e.g., a terahertz imaging device) built in.

A transceiver or network interface 212 transmits and receives signals between computer system 200 and other devices, such as another user device, a merchant server, an email server, application service provider, web server, a payment provider server, and/or other servers via a network. In various embodiments, such as for many cellular telephone and other mobile device embodiments, this transmission may be wireless, although other transmission mediums and methods may also be suitable. A processor 214, which may be a micro-controller, digital signal processor (DSP), or other processing component, processes these various signals, such as for display on computer system 200 or transmission to other devices over a network 216 via a communication link 218. Again, communication link 218 may be a wireless communication in some embodiments. Processor 214 may also control transmission of information, such as cookies, IP addresses, images, and/or the like to other devices.

Components of computer system 200 also include a system memory 220 (e.g., RAM), a static storage component 222 (e.g., ROM), and/or a disk drive 224. Computer system 200 performs specific operations by processor 214 and other components by executing one or more sequences of instructions contained in system memory 220. Logic may be encoded in a computer-readable medium, which may refer to any medium that participates in providing instructions to processor 214 for execution. Such a medium may take many forms, including but not limited to, non-volatile media, volatile media, and/or transmission media. In various implementations, non-volatile media includes optical or magnetic disks, volatile media includes dynamic memory such as system memory 220, and transmission media includes coaxial cables, copper wire, and fiber optics, including wires that comprise bus 202. In one embodiment, the logic is encoded in a non-transitory machine-readable medium. In one example, transmission media may take the form of acoustic or light waves, such as those generated during radio wave, optical, and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by computer system 200. In various other embodiments of the present disclosure, a plurality of computer systems 200 coupled by communication link 218 to the network (e.g., such as a LAN, WLAN, PTSN, and/or various other wired or wireless networks, including telecommunications, mobile, and cellular phone networks) may perform instruction sequences to practice the present disclosure in coordination with one another. Modules described herein may be embodied in one or more computer readable media or be in communication with one or more processors to execute or process the techniques and algorithms described herein.

A computer system may transmit and receive messages, data, information and instructions, including one or more programs (i.e., application code) through a communication link and a communication interface. Received program code may be executed by a processor as received and/or stored in a disk drive component or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer-readable media. It is also contemplated that software identified herein may be implemented using one or more computers and/or computer systems, networked and/or otherwise. Such software may be stored and/or used at one or more locations along or throughout the system, at client 102, network-based system 110, or both. Where applicable, the ordering of various steps described herein may be changed, combined into composite steps, and/or separated into sub-steps to provide features described herein.

The foregoing networks, systems, devices, and numerous variations thereof may be used to implement one or more services, such as the services discussed above and in more detail below.

The middle ear of a human being provides a particularly suitable biometric for authenticating individuals because certain characteristics of the middle ear are unique to an individual. The human middle ear contains three ossicles that transfer the vibrations of the eardrum into waves in the fluid and membranes of the inner ear. The three ossicles (i.e., the malleus, the incus, and the stapes) are small bones in the middle ear which are fully formed at birth. The stapes, in particular, is the only part of the human body that does not grow after birth. The combination of being unique per individual and maintain the same size for a lifetime, the size and the shape of the stapes makes for an ideal biometric for authentication.

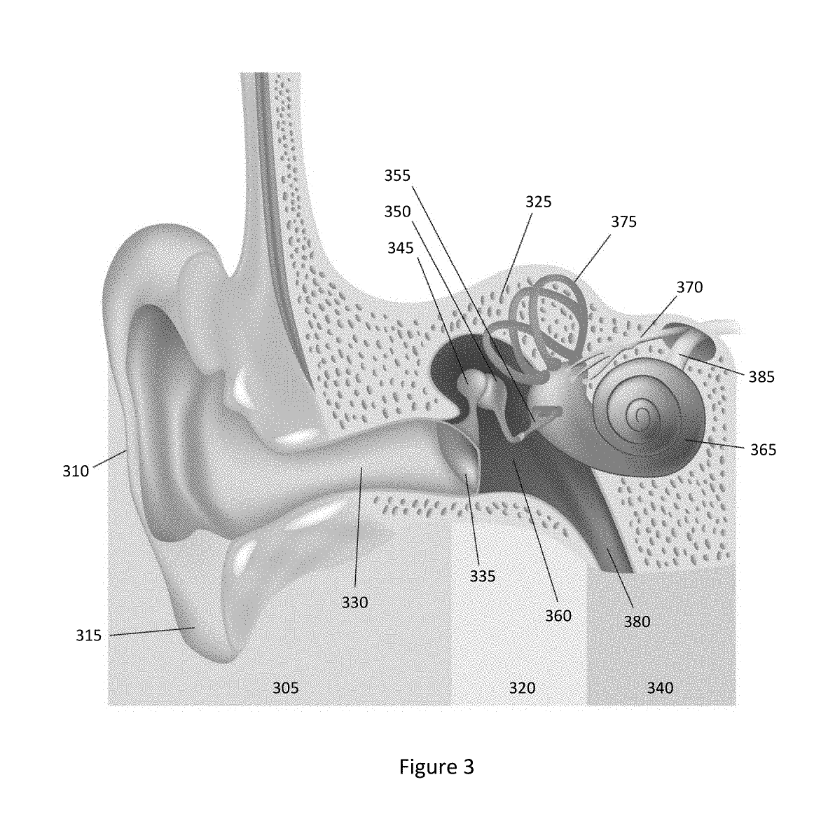

FIG. 3 provides an illustration of the anatomy of the ear. Hearing starts with the outer ear 305. The outer ear 305 includes the auricle 310 and earlobe 315. Connecting the outer ear to the middle ear 320, which is located within the temporal bone 325, is the auditory canal 330. The tympanic membrane (i.e., the eardrum) 335 divides the outer ear 305 from the middle ear 325. When a sound is made outside the outer ear 305, the sound waves travel down the auditory canal 330 and strike and vibrate the tympanic membrane 335.

The middle ear 320 consists of the ossicles which includes three connected small bones for transmitting the sound waves to the inner ear 340. The ossicles include the malleus 345, the incus 350, and the stapes 355, which are found in the tympanic cavity 360. The vibrations on the tympanic membrane 335 is passed to the ossicles. The ossicles amplify the sound and send the sound waves to the inner ear 340 and into the fluid-filled cochlea 365. As shown in FIG. 3, the stapes 355 is connected to the cochlea 365, which contains the nerves for hearing. The vestibule 370 and semicircular ducts 375, which are also part of the inner ear, contains the receptors for balance. Additionally, the eustachian tube 380, a canal that links the middle ear with the back of the nose is used to help to equalize pressure in the middle ear so that sound waves can be transferred properly. Once the sound waves reach the inner ear, they are converted into electrical impulses, which the cochlear nerve 380 sends to the brain. The brain then translates these electrical impulses as sound.

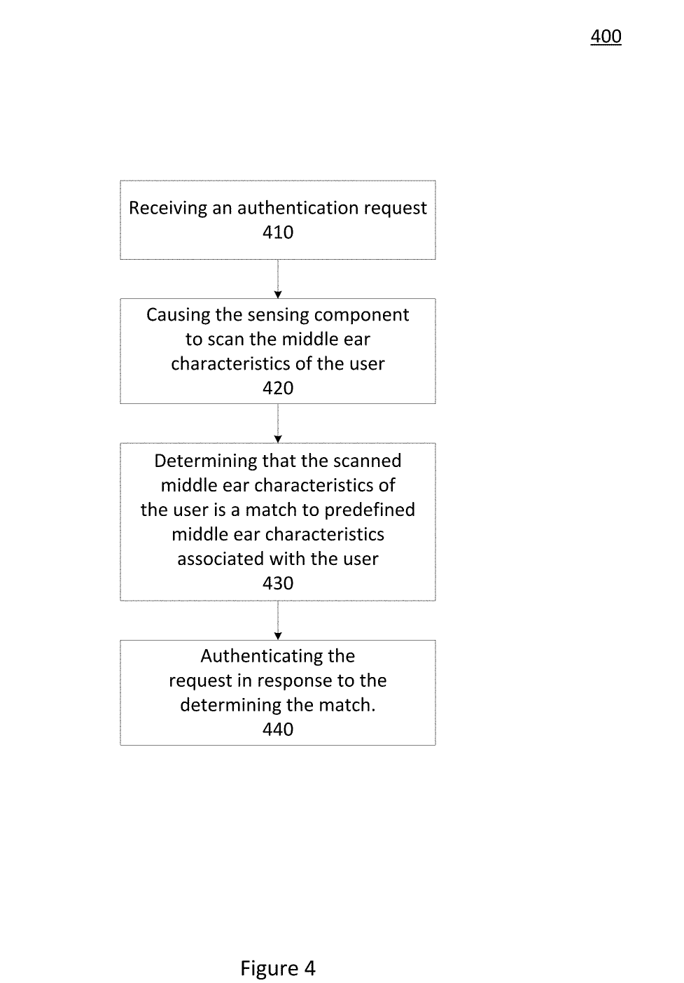

FIG. 4 illustrates an exemplary process 400 for authentication using middle ear biometric measurements. At operation 410 the system receives an authentication request. The authentication request may be for gaining access to a computing device (e.g., desktop, laptop, smartphone, tablet, etc.) via a log in or a screen unlock process. Alternatively, the request may be for initiating an application or program running on the computing device. For example, a user may try to access a personal account of a financial institution, or attempt to dial into a secure audio or video conference. Both of these services, which can be accessed via a browser or a native application, may require authentication to prevent unauthorized access.

In response to receiving the authentication request, an imaging device is caused to scan middle ear characteristics of the user in operation 420. In some embodiments, the size and shape of the middle ear may be used as a unique identifier for humans. For example, size and shape of the innermost ear ossicle (i.e., the stapes) can be measured. The ossicles, and in particular, the stapes, provide a suitable biometric for basing authentication on because unlike most other characteristics (e.g., facial features) of the human body, the ossicles are not only unique to an individual, but also do not change from birth. As such, the ossicles can be used as a structure on which authentication may be based for an indefinite period of time.

In order to measure the stapes and overall structure of the middle ear, a sensor equipped with terahertz imaging may be used. This sensor can be placed within an earbud or integrated with a smartphone (e.g., the smartphone camera). Terahertz imaging is generally used for security screenings, e.g., body scanners at airports. Radiation from such terahertz imaging devices is typically deployed in the 0.1 to 0.8 THz range because the skin is not transparent in this range. However, higher frequencies can be used to capture features beneath the skin. In some instances, higher frequencies may be used to detect skin cancer.

By utilizing longer wavelength radiation in the far-infrared region, terahertz imaging allows diagnostic close-to-surface tissue differentiation of bone morphology while also being harmless to human cells. Furthermore, bone and cartilaginous structures can be well differentiated from surrounding soft-tissues using terahertz imaging. Furthermore, terahertz radiation is particularly useful for identifying materials because it can be used in spectroscopy to measure the “unique spectral fingerprint” of a material. Using both the visual image produced from THz radiation, and the spectral fingerprint of the bones, a unique identifier of a person may be generated in the form of the shape and size of the ossicles of the individual.

Terahertz imaging is capable of a resolution of around a few tenths of a millimeter. However, using terahertz radiation generated by a femtosecond laser filament in air as the probe, the diameter of the terahertz beam, which propagates inside the filament, may vary from 20 μm to 50 μm, which is significantly smaller than the wavelength of the terahertz wave. Using this highly spatially confined terahertz beam as the probe, terahertz imaging with resolution as high as 20 μm (˜λ/38 at 0.4 THz) can be realized for obtaining a fine measurement of the middle ear ossicles.

Using terahertz imaging, the sensor can be used to image the structure of the middle ear through the skin. The identification of the ossicles can be further enhanced by spectroscopy as discussed above to determine if a structure being scanned is bone or cartilage. With the use of computer vision, the stapes and/or the other two middle ear ossicles (i.e., the malleus and the incus) can be identified and measured with high precision.

Once identified, the scanned middle ear characteristics of the user is compared to predefined middle ear characteristics associated with the user to determine whether or not a match exists in operation 430. For example, the user sets up authentication for a computing device or for an application by performing an initial scan of the middle ear. The scan may be performed multiple times to ensure the accuracy of the representation of the ossicles. Once a sufficient amount of data points has been recorded, and once there is a high enough level of consistency among the multiple scans, a predefined middle ear characteristic is established. Once the predefined version is established, future authentication scans can be compared to the predefined middle ear characteristics to determine if a match exists. As such, when an unauthorized user tries to gain access, the middle ear will determine that there's a difference between the anatomy of the unauthorized user and that which was predefined. Consequently, the unauthorized user will be denied access. Conversely, when an authorized users middle ear is scan, the scanned anatomy will presumably match the predefined middle ear characteristics, and thus, the user would be authenticated in operation 440.

After being authenticated, the user may be granted access to the computing device or a particular application running on the computing device. In some embodiments, the authentication process may be a continuous process. In other words, the authorized user may be required to keep the earbuds inside the ear for continuous scans to be performed (or for scans to be performed at a high frequency that would make it impractical for the user to remove the earbuds). When a scan determines at any time that the scanned ossicles are not the same as the predefined ones, the authentication is denied and whatever authenticated process or application that was previously running will cease to run.

For example, a user may participate in a conference call where security and confidentiality are necessary. When the user dials in, the user will be authenticated by a scan from the earbud or related device. To ensure that only the authorized user is able to hear the audio from the earbud, the system will continue to scan to ensure that the authorized user's ossicles are detected. If at any time the authorized user's ear is not detected (e.g., the user removes the earbud, or if an unauthorized user tries to use the earbud), the system will determine that there's an unauthorized use because it does not detect a match between the scan and the predefine middle ear characteristics. Once an unauthorized use is detected, all audio output from the earbud would immediately cease. In some embodiments, the corresponding computing device or application will be automatically shut down until authorized us is once against detected.

In some embodiments, the middle ear scan authentication process can be a part of a multi-factor authentication for a computing device. For example, if a user is trying to unlock the computing device for use, the user may first be prompted to enter a password. The user may then be required to insert the earbud. Once inserted, the earbud can perform a scan of the middle ear to determine whether the user is authorized based on the predefined middle ear characteristics. Once authorized via the scan, the computing device may play an audio message on the earbud. To complete the authentication, the user may be prompted by the audio to enter a string of text on the computing device. For example, the audio message may be a direct instruction to type out a specific string of characters. Alternatively, the audio message may prompt the user to answer a challenge question that the user knows the answer to (e.g., mother's maiden name, name of first pet, name of high school attended, etc.). If the user provides the correct answer or string of text to the computing device, the user is authenticated and thus authorized to use the computing device. Providing a multi-factor authentication in such a fashion reduces the risk of a device being hacked without adding a significant amount of overhead on the user side for the purpose of authentication.

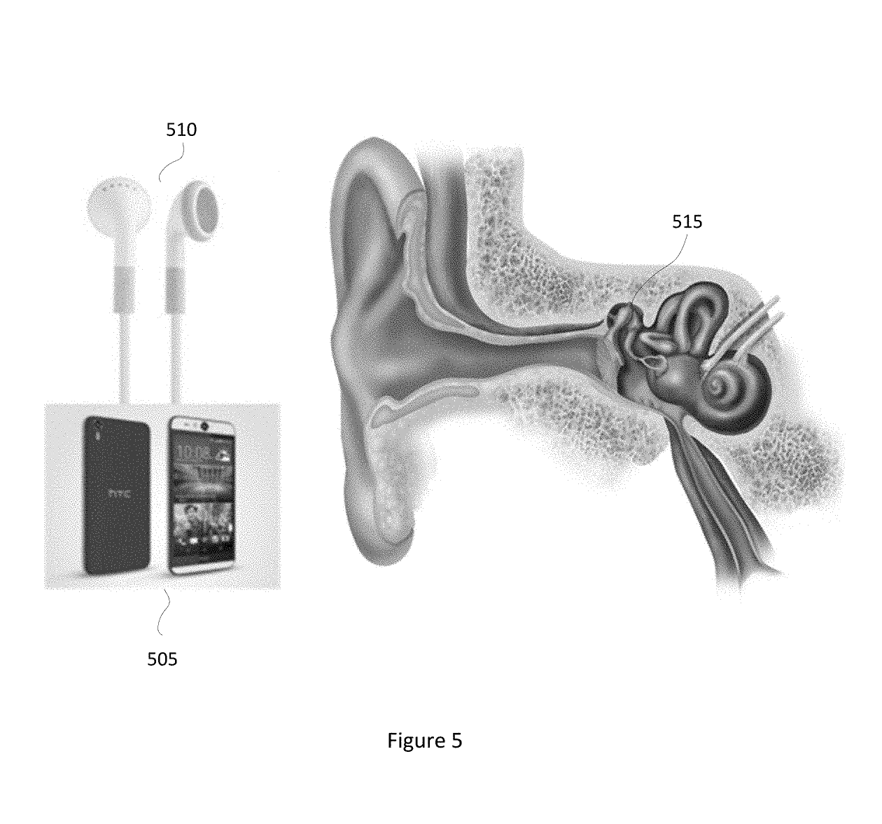

FIG. 5 provides an example of components of the system for performing authentication based on middle ear biometric measurements. Computing device 505 is communicative coupled to an imaging device 510. In this example, the computing device 505 is a smartphone and the imaging device 510 is integrated into a pair of earbuds. In some examples, the imaging device 510 may be integrated into the computing device 505. As discussed above, the imaging device 510 is equipped with terahertz imaging and spectroscopy technology to scan beneath the skin and bones and detect certain characteristics of the middle ear 515. Once the characteristics (e.g., size, shape and spectroscopy fingerprint) of the middle ear 515 has been calculated, that data is returned to the computing device 505 for analysis. Once the data is received, the computing device 505 compares it against predefined middle ear characteristics that were previously stored on the computing device 505. The computing device 505 then either confirms or denies the authentication of the individual based on the comparison.

The user device (i.e., the computing device) described above may be one of a variety of devices including but not limited to a smartphone, a tablet, a laptop and a pair of augmented reality spectacles. Each of these devices embodies some processing capabilities and an ability to connect to a network (e.g., the internet, a LAN, a WAN, etc.). Each device also includes a display element for displaying a variety of information. The combination of these features (display element, processing capabilities and connectivity) on the mobile communications enables a user to perform a variety of essential and useful functions.

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology.

There may be many other ways to implement the subject technology. Various functions and elements described herein may be partitioned differently from those shown without departing from the scope of the subject technology. Various modifications to these configurations will be readily apparent to those skilled in the art, and generic principles defined herein may be applied to other configurations. Thus, many changes and modifications may be made to the subject technology, by one having ordinary skill in the art, without departing from the scope of the subject technology.

It is understood that the specific order or hierarchy of steps in the processes disclosed is an illustration of exemplary approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

A phrase such as “an aspect” does not imply that such aspect is essential to the subject technology or that such aspect applies to all configurations of the subject technology. A disclosure relating to an aspect may apply to all configurations, or one or more configurations. An aspect may provide one or more examples of the disclosure. A phrase such as an “aspect” may refer to one or more aspects and vice versa. A phrase such as an “implementation” does not imply that such implementation is essential to the subject technology or that such implementation applies to all configurations of the subject technology. A disclosure relating to an implementation may apply to all implementations, or one or more implementations. An implementation may provide one or more examples of the disclosure. A phrase such an “implementation” may refer to one or more implementations and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples of the disclosure. A phrase such as a “configuration” may refer to one or more configurations and vice versa.

Furthermore, to the extent that the terms “include,” “have,” and “the like” are used in the description or the claims, such terms are intended to be inclusive in a manner similar to the term “comprise” as “comprise” is interpreted when employed as a transitional word in a claim.

The word “exemplary” is used herein to mean “serving as an example, instance, or illustration.” Any implementation described herein as “exemplary” is not necessarily to be construed as preferred or advantageous over other implementations.

A reference to an element in the singular is not intended to mean “one and only one” unless specifically stated, but rather “one or more.” The term “some” refers to one or more. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

What is claimed is:

1. A system for authenticating a user, comprising:
an imaging device operative to scan middle ear characteristics of a user;
a non-transitory memory storing instructions; and
one or more hardware processors coupled to the non-transitory memory and configured to read the instructions from the non-transitory memory to cause the system to perform operations comprising:
receiving an authentication request;
causing, in response to the received authentication request, the imaging device to scan the middle ear characteristics of the user;
determining that the scanned middle ear characteristics of the user is a match to predefined middle ear characteristics associated with the user; and
authenticating the request in response to the determining the match.

2. The system of claim 1, wherein the imaging device is a terahertz imaging device.

3. The system of claim 2, wherein scanning the middle ear characteristics of the user includes scanning middle ear ossicles of the user with the terahertz imaging device.

4. The system of claim 3, wherein determining that the scanned middle ear characteristics of the user is a match to the predefined middle ear characteristics associated with the user comprises comparing the scanned middle ear ossicles to a set of predefined middle ear ossicles associated with the user.

5. The system of claim 4, wherein scanning the middle ear ossicles of the user comprises scanning a stapes of the user using the terahertz imaging device.

6. The system of claim 5, wherein determining that the scanned middle ear characteristics of the user is a match to the predefined middle ear characteristics associated with the user comprises comparing the scanned stapes to a predefined stapes associated with the user.

7. The system of claim 5, wherein scanning the stapes comprises determining a size and a shape of the stapes.

8. The system of claim 7, wherein scanning the middle ear characteristics of the user further comprises using spectroscopy to determine materials of the middle ear characteristics to identify the ossicles.

9. The system of claim 1, wherein the authentication request is a continuous authentication request, and wherein the imaging device is caused to continuously scan the middle ear characteristics of the user.

10. The system of claim 9, further comprising denying the authentication request when the scanned middle ear characteristics of the user is determined to not match the predefined middle ear characteristics associated with the user at any time during the continuous authentication request.

11. The system of claim 1, wherein the imaging device is integrated into a headphone.

12. A method comprising:
receiving a request for continuous authentication in response to an initiation of an application on a computing device;
causing the imaging device to continuously scan middle ear characteristics of a user upon initiation of the application;
allowing the application to operate when a determination that the scanned middle ear characteristics of the user is a match to predefined middle ear characteristics associated with the user is made; and
discontinuing the application from operating when a determination that the scanned middle ear characteristics of the user is not a match to the predefined middle ear characteristics associated with the user is made.

13. The method of claim 12, wherein the imaging device is a terahertz imaging device, and wherein scanning the middle ear characteristics of the user includes scanning middle ear ossicles of the user with the terahertz imaging device.

14. The method of claim 12, wherein the application is for secure communication between two or more parties.

15. The method of claim 14, wherein allowing the application to operate comprises providing audio conferencing capabilities to the two or more parties, and wherein discontinuing the application from operating comprises cutting off the communication between the two or more parties.

16. A non-transitory machine-readable medium having stored thereon machine-readable instructions executable to cause performance of operations comprising:
receiving an authentication request;
causing, in response to the received authentication request, an imaging device integrated into a headphone to scan the middle ear characteristics of a user;
determining that the scanned middle ear characteristics of the user is a match to predefined middle ear characteristics associated with the user;
playing, through the headphone in response to determining the match, instructions for entering a string of text on a computing device;
determining that the entered string of text matches a predefined string of text; and
authenticating the user for the computing device in response to determining the match in the string of text.

17. The non-transitory machine-readable medium of claim 16, instructions for entering a string of text on the computing device is a challenge question.

18. The non-transitory machine-readable medium of claim 16, wherein the imaging device is a terahertz imaging device, and wherein scanning the middle ear characteristics of the user includes scanning middle ear ossicles of the user with the terahertz imaging device.

19. The non-transitory machine-readable medium of claim 18, wherein scanning the middle ear ossicles of the user comprises scanning a stapes of the user using the terahertz imaging device, and wherein determining that the scanned middle ear characteristics of the user is a match to the predefined middle ear characteristics associated with the user comprises comparing the scanned stapes to a predefined stapes associated with the user.

20. The non-transitory machine-readable medium of claim 19, wherein the predefined middle ear characteristics is determined during an initial setup of the computing device.
